(19) United States
(12) Patent Application Publication
(10) Pub. No.: US 2012/0023818 A1
(43) Pub. Date: Feb. 2, 2012

(54) PLANT SUPPORT DEVICE

(76) Inventor: Anny R. RASMUSSEN, Naples, FL (US)

(21) Appl. No.: 12/844,137

(22) Filed: Jul. 27, 2010

(51) Int. Cl. A01G 13/00

(52) U.S. Cl. 47/45; 47/46

(57) ABSTRACT

A plant support device (1) having a horizontal support (3) with vertical stakes (10) extending downward therefrom. The stakes may be height adjustable to accommodate various heights of different plants (2) and to allow a user to increase the height of the plant support device as a plant grows. The horizontal support is preferably made of a flexible material that allows a user to curve it around an entire plant to create a ring (13) that encircles the entire plant or to create a partial ring (21) that supports only one side of the plant. The diameter of the ring may be adjusted to accommodate various widths of different plants and to allow a user to increase the diameter of the ring as a plant grows. Multiple plant support devices may also be attached to one another to enlarge the diameter of the ring.

### BACKGROUND OF THE INVENTION

This invention relates to plant supports, more particularly, an adjustable plant support device used for supporting the vertical growth of plants.

Many plants need to be supported to keep them from falling over when they get too tall or top-heavy. Conventional plant supports include stakes and rings. Stakes are used by inserting the stake into the soil next to the stem of a plant. The stem must then be secured to the stake with string or clips. A common problem with stakes is that, as the plant grows, the stake or stakes supporting the plant need to be repositioned and re-secured to the plant. If a plant is allowed to grow without repositioning the stake, then the stem of the plant can be damaged. This is especially true when the plant is tied to the stake and the string is not loosened, thereby allowing the string to dig into the growing plant. On the other hand, rings are only available in a fixed diameter. Therefore rings can restrict the horizontal growth of a plant. A smaller ring can be replaced with a larger ring as a plant grows. However, the smaller ring must be pulled up over the top of the plant to remove it, which can constrict and damage the vegetation on the plant, especially the larger vegetation at the top of the plant. This is also true when placing the larger ring over the top of the plant. An even further problem with conventional ring supports is that they encircle the entire plant and, thus detract from the aesthetic beauty of a plant.

Therefore, a need exists for a plant support device that supports the vertical growth of a plant, is size adjustable, can be placed on a plant without harming the plant's vegetation and does not detract from the aesthetic beauty of a plant.

The relevant prior art includes the following patent references:

| Patent/Serial No. | Inventor | Issue/Publication Date |
|---|---|---|
| 2006/0254137 | Lin | Nov. 16, 2006 |
| 7,043,876 | LaPelusa | May 16, 2006 |
| 7,020,998 | Kirkland et al. | Apr. 04, 2006 |
| 2006/0042159 | LaPelusa | Mar. 02, 2006 |
| 6,912,809 | Malofsky et al. | Jul. 05, 2005 |
| 6,681,520 | Kleinert | Jan. 27, 2004 |
| 2003/0159347 | Malofsky et al. | Aug. 28, 2003 |
| 6,408,569 | Obregon | Jun. 25, 2002 |
| 6,389,743 | Stephenson | May 21, 2002 |
| D411,722 | Grimes | Jun. 29, 1999 |
| 4,750,293 | Dyke | Jun. 14, 1988 |
| 5,595,019 | Foreman | Jan. 21, 1997 |
| 5,542,210 | Hupfl | Aug. 06, 1996 |
| 5,327,678 | Schweiker | Jul. 12, 1994 |
| 4,534,129 | Stuckey | Aug. 13, 1985 |
| 4,519,162 | Stuckey | May 28, 1985 |
| 4,503,636 | Stuckey | Mar. 12, 1985 |
| FR2,536,247 | Vatan | May 21, 1984 |
| 3,778,929 | Pearson | Dec. 18, 1973 |
| 3,471,968 | Letz | Oct. 14, 1969 |
| 2,782,561 | Smith | Feb. 26, 1957 |

### SUMMARY OF THE INVENTION

The primary object of the present invention is to provide a plant support device that supports the vertical growth of a plant.

Another object of the present invention is to provide a plant support device that supports a plant without damaging the plant.

An even further object of the present invention is to provide a plant support device that can be placed on a plant from the side and does not have to be put over the top of a plant.

Another object of the present invention is to provide a plant support device that does not detract from the aesthetic beauty of a plant.

An even further object of the present invention is to provide a plant support device wherein the diameter of the device may be adjusted.

An additional object of the present invention is to provide a plant support device that is height adjustable.

The present invention fulfills the above and other objects by providing a plant support device comprising a horizontal support having a outer surface, a inner surface, a top edge, a bottom edge, a first end and a second end. At least one vertical stake extends downward from the bottom edge of the horizontal support. The at least one stake may be inserted into the soil around a plant being supported. The stakes may be height adjustable, such as a telescoping stake, to accommodate various heights of different plants and to allow a user to increase the height of the plant support device as a plant grows. The horizontal support is preferably made of a flexible material that allows a user to curve it around an entire plant to create a ring that encircles the entire plant. The first end of the horizontal support may then be attached to the second end of the horizontal support via an attachment means, such as a hook and loop fastener, snaps, a tab and slots, adhesive, etc. The attachment means allows a user to adjust the diameter of the ring created by the horizontal support to accommodate various widths of different plants and to allow a user to increase the diameter of the ring as a plant grows.

A user may also create a larger ring by placing multiple plant support devices end to end. The multiple plant support devices may be placed next to each other or attached to each other via the attachment means in order to strengthen the ring created by the multiple horizontal sections.

In situations where a plant is only leaning to one side, a partial ring may be created by only curving the plant support device partially around the plant. This also allows a user to position the plant support device so that it is hidden behind a plant and out of sight so that the plant support device does not detract from the aesthetic beauty of the plant.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective side view of the a plant support device of the present invention fully encircling a plant;

FIG. 2 is a perspective side view of multiple plant support devices of the present invention attached to each other and fully encircling a plant;

FIG. 3 is a perspective side view of a plant support device having a horizontal support extension attached thereto;

FIG. 4 is a perspective side view of a plant support device of the present invention partially encircling a plant;

FIG. 5 is a side view laid flat of the inner surface of a plant support device of the present invention;

FIG. 6 is side view laid flat of the inner surface of a plant support device of the present invention having a tab and slots as an attachment means;

FIG. 7 is a side plan view laid flat of the inner surface of a plant support device of the present invention having a hook and loop fastener as an attachment means; and

FIG. 8 is a side view laid flat of the inner surface of a plant support device of the present invention having snaps as an attachment means.

### DESCRIPTION OF THE PREFERRED EMBODIMENTS

For purposes of describing the preferred embodiment, the terminology used in reference to the numbered components in the drawings is as follows:

| | |
|---|---|
| 1. | plant support device |
| 2. | plant |
| 3. | horizontal support |
| 4. | outer surface |
| 5. | inner surface |
| 6. | top edge |
| 7. | bottom edge |
| 8. | first end |
| 9. | second end |
| 10. | stake |
| 11. | soil |
| 12. | telescoping stake |
| 13. | ring |
| 14. | attachment means |
| 15. | adhesive |
| 16. | hook and loop fastener |
| 17. | snap |
| 18. | tab |
| 19. | slot |
| 20. | horizontal support extension |
| 21. | partial ring |

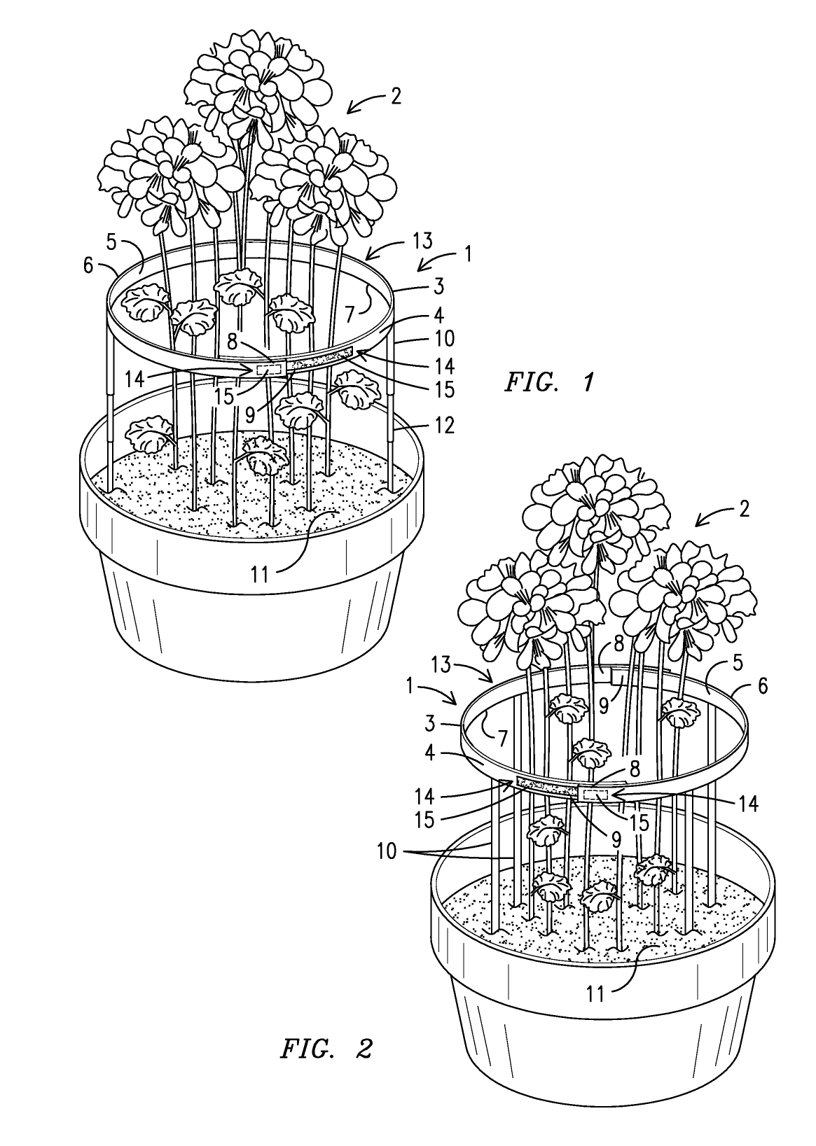

With reference to FIG. 1, a perspective side view of the a plant support device 1 of the present invention fully encircling a plant 2 is shown. The plant support device 1 comprises a horizontal support 3 having a outer surface 4, a inner surface 5, a top edge 6, a bottom edge 7, a first end 8 and a second end 9. Vertical stakes 10 extend downward from the bottom edge 7 of the horizontal support 3. The vertical stakes 10 are inserted into the soil 11 around plant 2 being supported. The stakes 10 may be height adjustable. As shown here, the stakes may be telescoping stakes 12 to accommodate various heights of different plants 2 and to allow a user to increase the height of the plant support device 1 as the plant 2 grows. The horizontal support 3 has been curved around the entire plant 2 so that the horizontal support 3 creates a ring 13 encircling the entire plant 2. The first end 8 has been attached to the second end 9 via an attachment means 14, such as an adhesive 15, a hook and loop fastener 16 (as shown in FIG. 7), snaps 17 (as shown in FIG. 8), a tab 18 and slots 19 (as shown in FIG. 6), etc. The attachment means 14 allows a user to adjust the diameter of the ring 13 created by the horizontal support 3 to accommodate various widths of different plants 2 and to allow a user to increase the diameter of the ring 13 as the plant 2 grows.

With reference to FIG. 2, a perspective side view of multiple plant support devices 1 of the present invention attached to each other and fully encircling a plant 2 is shown. The plant support devices 1 each comprise a horizontal support 3 having a outer surface 4, a inner surface 5, a top edge 6, a bottom edge 7, a first end 8 and a second end 9. Vertical stakes 10 extend downward from the bottom edges 7 of the horizontal supports 3. The horizontal supports 3 of the plant support devices 1 have been curved and the first ends 8 of the horizontal supports 3 have been attached to the second ends 9 of the horizontal supports 3 via an attachment means 14 to create a ring 13 that encircles the entire plant 2.

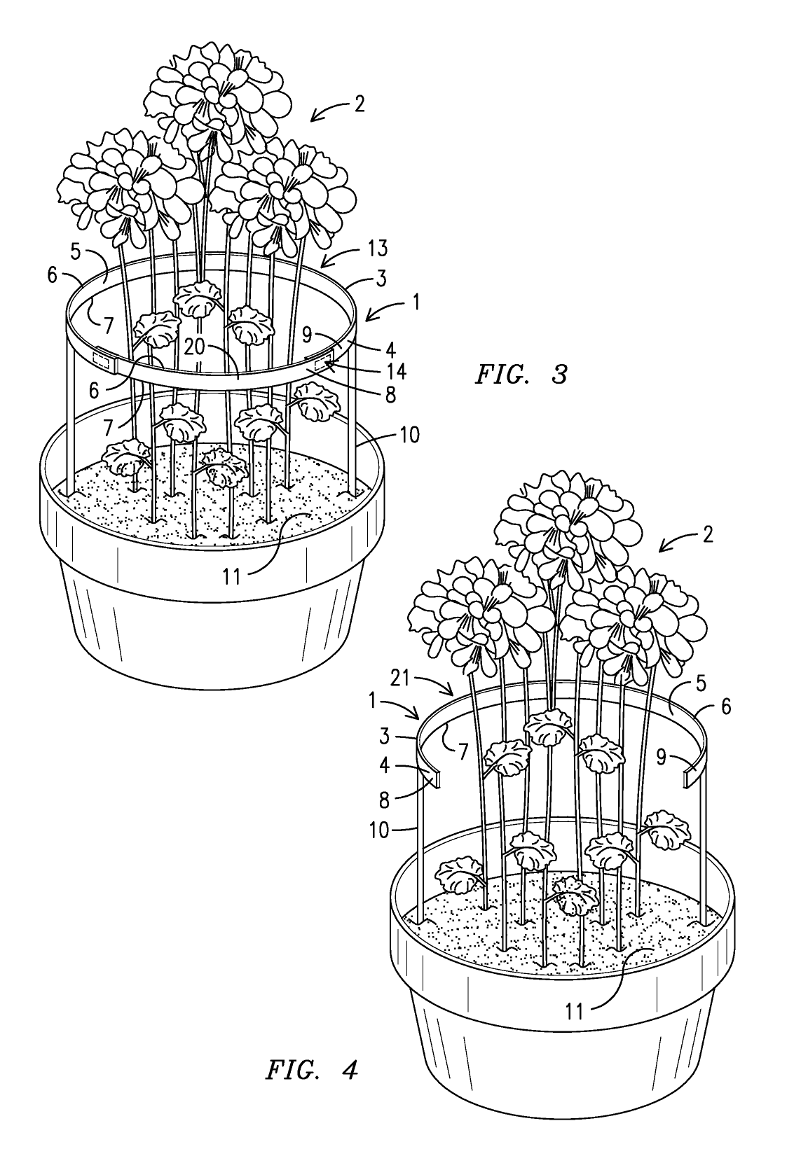

With reference to FIG. 3, a perspective side view of a plant support device 1 having a horizontal support extension 20 attached thereto is shown. The plant support devices 1 each comprise a horizontal support 3 having a outer surface 4, a inner surface 5, a top edge 6, a bottom edge 7, a first end 8 and a second end 9. Vertical stakes 10 extend downward from the bottom edges 7 of the horizontal supports 3. A horizontal support extension 20 having a outer surface 4, a inner surface 5, a top edge 6, a bottom edge 7, a first end 8 and a second end 9 has been attached to the horizontal support 3 via an attachment means 14 to create a ring 13 around a plant 2. The horizontal support extension 20 allows a user to adjust the diameter of the ring 13 to accommodate various widths of different plants 2 and to allow a user to increase the diameter of the ring 13 as the plant 2 grows.

With reference to FIG. 4, a perspective side view of a plant support device 1 of the present invention partially encircling a plant 2 is shown. The plant support devices 1 each comprise a horizontal support 3 having a outer surface 4, a inner surface 5, a top edge 6, a bottom edge 7, a first end 8 and a second end 9. Vertical stakes 10 extend downward from the bottom edges 7 of the horizontal supports 3. The horizontal plant support device 1 may be used to support a plant 2 that is only leaning to one side, a partial ring 21 may be created by only curving the plant support device 1 partially around the plant 2. This also allows a user to position the plant support device 1 so that it is hidden behind the plant 2 and out of sight so that the plant support device 1 does not detract from the aesthetic beauty of the plant 2.

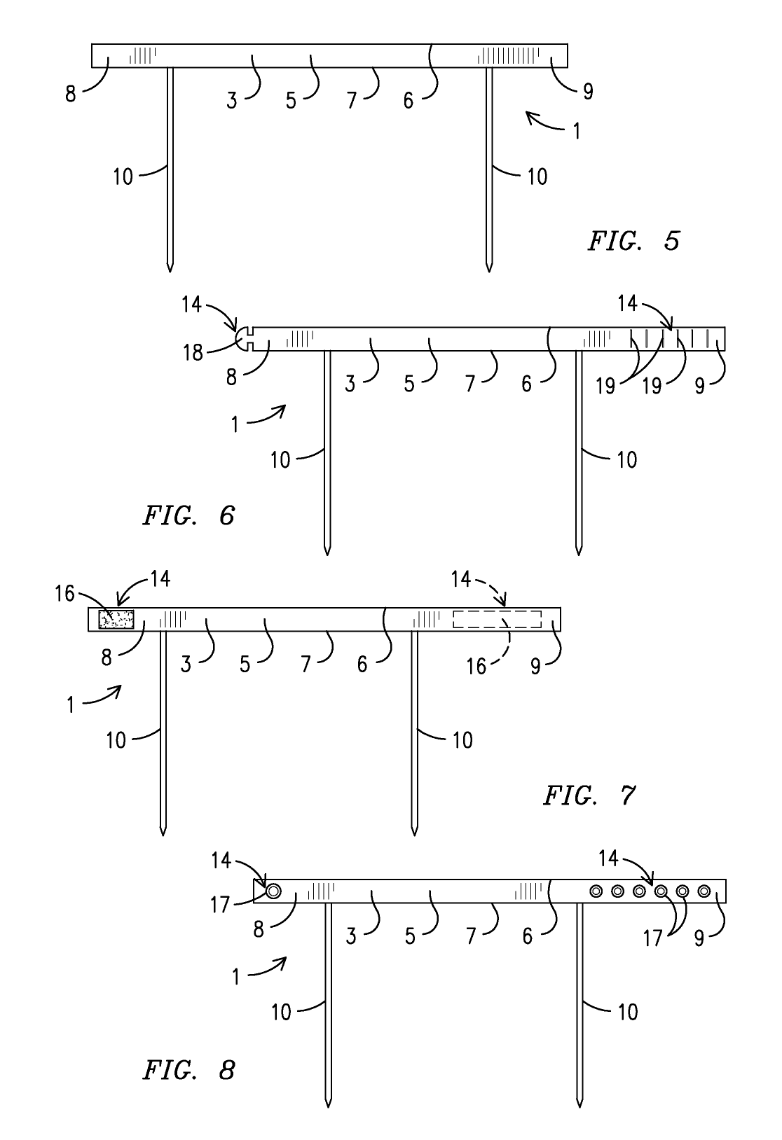

With reference to FIG. 5, a side view laid flat of the inner surface 5 of a plant support device 1 of the present invention is shown. The plant support device 1 comprises a horizontal support 3 having a outer surface 4 (as shown in the FIGS. 1-4), a inner surface 5, a top edge 6, a bottom edge 7, a first end 8 and a second end 9. Vertical stakes 10 extend downward from the bottom edges 7 of the horizontal support 3.

With reference to FIG. 6, a side view laid flat of the inner surface of a plant support device 1 of the present invention having a tab 18 and slots 19 as an attachment means 14 is shown. The plant support device 1 comprises a horizontal support 3 having a outer surface 4 (as shown in the FIGS. 1-4), a inner surface 5, a top edge 6, a bottom edge 7, a first end 8 and a second end 9. Vertical stakes 10 extend downward from the bottom edges 7 of the horizontal support 3. The tab 18 and slots 19 allow a user to attach the first end 8 of the horizontal support 3 to the second end 9 of the horizontal support 3.

With reference to FIG. 7, a side plan view laid flat of the inner surface of a plant support device 1 of the present invention having a hook and loop fastener 16 as an attachment means 14 is shown. The plant support device 1 comprises a horizontal support 3 having a outer surface 4 (as shown in the FIGS. 1-4), a inner surface 5, a top edge 6, a bottom edge 7, a first end 8 and a second end 9. Vertical stakes 10 extend downward from the bottom edges 7 of the horizontal support 3. The hook and loop fastener 16 allows a user to attach the first end 8 of the horizontal support 3 to the second end 9 of the horizontal support 3.

Finally with reference to FIG. 8, a side view laid flat of the inner surface of a plant support device 1 of the present invention having snaps 17 as an attachment means 14 is shown. The plant support device 1 comprises a horizontal support 3 having a outer surface 4 (as shown in the FIGS. 1-4), a inner surface 5, a top edge 6, a bottom edge 7, a first end 8 and a second end 9. Vertical stakes 10 extend downward from the bottom edges 7 of the horizontal support 3. The snaps 17 allow a user to attach the first end 8 of the horizontal support 3 to the second end 9 of the horizontal support 3.

It is to be understood that while a preferred embodiment of the invention is illustrated, it is not to be limited to the specific form or arrangement of parts or use herein described and shown. It will be apparent to those skilled in the art that various changes may be made without departing from the scope of the invention and the invention is not to be considered limited to what is shown and described in the specification and drawings.

1. (canceled)

2. The plant support device of claim 13 further comprising an attachment means located on the first end and the second end of the horizontal support.

3. (canceled)

4. The plant support device of claim 2 wherein said attachment means is a tab and at least one slot.

5. (canceled)

6-12. (canceled)

13. A plant support device comprising: a horizontal support having an outer surface, an inner surface, a top edge, a bottom edge, a first end
and a second end, said horizontal support is made of a flexible material, and at least two stakes are extending downward from the bottom edge of the horizontal support.

14. The plant support of claim 13 further comprising an attachment means located on the first end and the second of the horizontal support.

15-21. (canceled)
